(19) United States
(12) Patent Application Publication
(10) Pub. No.: US 2023/0409031 A1
(43) Pub. Date: Dec. 21, 2023

(54) CONTROL METHOD FOR UNMANNED AERIAL VEHICLE, DEVICE, REMOTE CONTROLLER AND STORAGE MEDIUM

(71) Applicant: SZ DJI TECHNOLOGY CO., LTD., Shenzhen (CN)

(72) Inventors: Wuyang DUAN, Shenzhen (CN); Xiang LI, Shenzhen (CN)

(73) Assignee: SZ DJI TECHNOLOGY CO., LTD., Shenzhen (CN)

(21) Appl. No.: 18/240,294

(22) Filed: Aug. 30, 2023

Related U.S. Application Data
(63) Continuation of application No. PCT/CN2021/078768, filed on Mar. 2, 2021.

(51) Int. Cl. G05D 1/00; G05D 1/10

(52) U.S. Cl. CPC G05D 1/0061; G05D 1/0066; G05D 1/101; B64U 10/00

(57) ABSTRACT

A UAV control method and device, a remote controller and a storage medium are provided. The method includes: obtaining UAV control mode switching request information to request to switch from a first control mode to a second control mode; in response to the switching request information, detecting whether the position of an accelerator control member in its operating range is within a region of hovering range. In the second control mode, when the accelerator control member is within the region of hovering range, the UAV maintains a hovering state in a vertical direction; if it is detected that the accelerator control member is located in the region of hovering range, the control mode of the UAV is switched from the first control mode to the second control mode, otherwise, refuse to switch the control mode of the UAV from the first control mode to the second control mode.

### RELATED APPLICATIONS

This application is a continuation application of PCT application No. PCT/CN2021/078768, filed on Mar. 2, 2021, and the content of which is incorporated herein by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the technical field of unmanned aerial vehicle (UAV), in particular to a control method and device of an unmanned aerial vehicle, a remote controller and a storage medium.

### BACKGROUND

Nowadays, UAVs generally have multiple control modes, such as a normal control mode, a manual control mode, and other control modes. For different control modes, the mapping of the amount of power control lever/member displacement (the position of the power control lever in the operating range) of the power control lever of the remote controller may also be different. In some control modes, when the power control lever of the remote controller is in the middle of its operating range, the UAV may hover in a vertical direction. For example, in the normal control mode, the amount of power control lever displacement of the remote controller may be mapped to a vertical velocity command of the UAV. When the power control lever of the remote controller returns to the middle position, the vertical velocity of the UAV is zero. In some control modes, when the power control lever of the remote controller is in the middle position of its operating range, the UAV cannot hover in the vertical direction. For example, in the manual control mode, the amount of power control lever displacement of the remote controller may be mapped to the power control value of a power motor of the UAV. When the power control lever is in the middle position of the operating range, the mapped power control value may not be the power control value that indicates the UAV to hover in the vertical direction. Thus, when the control mode in which the UAV hovers in the vertical direction when the power control lever of the remote controller is in the middle position of the operating range is switched to a control mode in which the UAV cannot hover in the vertical direction when the power control lever of the remote controller is in the middle position of the operating range, the UAV may rise or fall rapidly in the vertical direction, causing UAV to crash/fall apart.

Therefore, how to control the UAV to safely switch its control mode has become an urgent problem to be solved.

### SUMMARY

In light of the foregoing, the present disclosure provides a control method and device of a UAV, a remote controller and a storage medium, in order to safely switch the control mode of the UAV.

In a first aspect, the present disclosure provides a method for controlling an aircraft, including: obtaining request information, where the request information is configured to request switching a control mode of the aircraft to a preset control mode; detecting, based on the request information, whether a current position of an accelerator control member of a remote controller of the aircraft is within a preset range region; in response to the current position of the accelerator control member being within the preset range region, controlling the aircraft to enter a preset control mode; and in response to the current position of the accelerator control member not being within the preset range region, prohibiting the aircraft from entering the preset control mode.

In a second aspect, the present disclosure provides another method for controlling an aircraft, including: obtaining request information, where the request information is configured to request switching a control mode of the aircraft to a preset control mode; detecting, based on the request information, whether a current position of an accelerator control member of a remote controller of the aircraft is within a preset range region; in response to the current position of the accelerator control member being within the preset range region, controlling the aircraft to enter a preset control mode; and controlling the aircraft to maintain a hovering state in a vertical direction when the aircraft enters the preset control mode.

In a third aspect, the present disclosure provides a control device for an aircraft, including: at least one storage medium storing a set of instructions for aircraft controlling; and at least one processor in communication with the at least one storage medium, where during operation, the at least one processor executes the set of instructions to: obtain request information, where the request information is configured to request switching a control mode of the aircraft to a preset control mode, detect, based on the request information, whether a current position of an accelerator control member of a remote controller of the aircraft is within a preset range region, in response to the current position of the accelerator control member being within the preset range region, control the aircraft to enter a preset control mode, and in response to the current position of the accelerator control member not being within the preset range region, prohibit the aircraft from entering the preset control mode.

According to the control method and device of a UAV, the remote controller and the storage medium provided in the present disclosure, when control mode switching request information of the UAV (for requesting to switch the control mode of the UAV from the first control mode to the second control mode) is received, in response to the switching request information, detect whether the position of the accelerator control member of the remote controller of the UAV in its operating range is located in a hover range region; if the control mode of the UAV is the first control mode, when the accelerator control member is in the middle position of its operating range, the UAV keeps hovering in the vertical direction, if the control mode of the UAV is the second control mode, when the accelerator control member is in the middle position of its operating range, the UAV cannot maintain a hovering state in the vertical direction, when the accelerator control member is in the hover region, the UAV keeps hovering in the vertical direction. If it is detected that the accelerator control member is located in the hover region, the control mode of the UAV is switched from the first control mode to the second control mode; otherwise, refuse to switch the control mode of the UAV from the first control mode to the second control mode. In this way, the situation where the UAV may soar rapidly or even crash/fall apart may be avoided. Therefore, it is ensured that the UAV switches its control mode safely.

It is to be understood that both the foregoing general description and the following detailed description are exemplary and explanatory only, and are not restrictive of the present disclosure.

### BRIEF DESCRIPTION OF THE DRAWINGS

In order to more clearly illustrate the technical solutions of the embodiments of the present disclosure, the following will briefly introduce the drawings for the description of some exemplary embodiments. Apparently, the drawings in the following description are merely some embodiments of the present disclosure. For a person skilled in the art, other drawings may also be obtained based on these drawings without creative efforts.

FIG. 1 is a schematic diagram of the structure of a remote controller according to some exemplary embodiments of the present disclosure;

FIG. 2 is a schematic flowchart of the steps of a control method for a UAV according to some exemplary embodiments of the present disclosure;

FIG. 3 is a schematic flowchart of the steps of a control method for a UAV according to some exemplary embodiments of the present disclosure;

FIG. 4 is a schematic diagram of an interface displaying a graphic indicator according to some exemplary embodiments of the present disclosure;

FIG. 5 is a schematic flowchart of the steps of a control method for a UAV according to some exemplary embodiments of the present disclosure; and

FIG. 6 is a schematic block diagram of a control device for an UAV according to some exemplary embodiments of the present disclosure.

### DETAILED DESCRIPTION

With reference to the accompanying drawings for some exemplary embodiments, the technical solutions of some exemplary embodiments of the present disclosure will be described below in details. Apparently, the described exemplary embodiments are some of the embodiments of the present disclosure, but not all of them. Based on the exemplary embodiments described herein, all other embodiments obtained by a person of ordinary skill in the art without making creative efforts should fall within the scope of protection of the present disclosure.

The flowcharts shown in the accompanying drawings are illustrative only. They do not necessarily include all contents and operations/steps, nor do they have to be performed in the order as described. For example, some operations/steps may also be separated, combined or partially combined. Therefore, the actual execution order may be changed according to the actual situations.

It should be understood that the terms used herein are for the purpose of describing certain exemplary embodiments only, and are not intended to limit the present disclosure. As used in this disclosure and the appended claims, the singular forms “a,” “an” and “the” are intended to include plural forms thereof unless the contexts explicitly dictate otherwise.

It should also be understood that the term “and/or” used in the description of the present disclosure and the appended claims refers to any combination and all possible combinations of one or more of the listed associated items, and includes these combinations.

Some exemplary embodiments of the present disclosure will be described in detail below in conjunction with the accompanying drawings. In the case of no conflict, the following exemplary embodiments and features in these exemplary embodiments may be combined with one another.

Embodiments of the present disclosure provide a control method and device for a UAV, a remote controller, and a storage medium, which may be used to ensure that the UAV may switch its control mode safely.

The UAV herein may include a traversing aircraft, a rotorcraft, etc., for example, a single rotor aircraft, a dual rotor aircraft, a tri-rotor aircraft, a quad-rotor aircraft, a hexa-rotor aircraft, an octa-rotor aircraft, a deca-rotor aircraft, a dodeca-rotor aircraft, and the like. Of course, the UAV may also be other types of unmanned aerial vehicles or movable devices; this is not limited herein (the UAV described herein is merely an example, and the present disclosure may cover any type of aircraft).

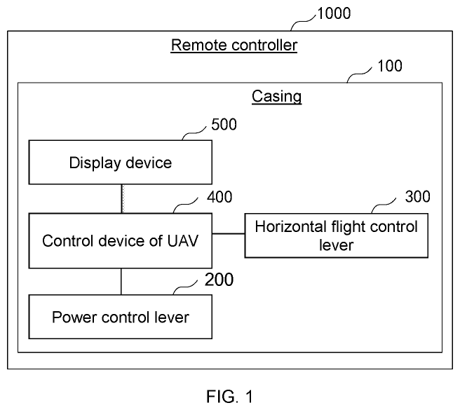

With reference to FIG. 1, FIG. 1 is a schematic diagram of the structure of a remote controller according to some exemplary embodiments of the present disclosure. As shown in this figure, a remote controller 1000 may include a casing 100, an accelerator control member 200, a horizontal flight control member 300 (the present disclosure does not limit the specific format, shape, etc. of the accelerator control member and the horizontal flight control member, for example they may be power control levers and horizontal flight control levers, or may be any other types of control members as long as they have the function of power control or horizontal flight control. In addition, the accelerator control member herein refers to any device that can control, via an accelerator or a similar device or a different device with a similar function, the speed of a motor (may be powered by direct current (DC), alternating current (AC) or both, or an engine (may be powered by a fuel in any form, such as gas, liquid, solid, etc.), and a control device 400 of a UAV.

The control mode of UAV includes, but is not limited to, a first control mode (such as a normal control mode) and a second control mode (such as a manual control mode). When the control mode of the UAV is the first control mode, the position of the accelerator control member 200 in its operating range may be mapped to the velocity of the UAV in the vertical direction. Exemplarily, in the case where the control mode of the UAV is the first control mode, when the accelerator control member 200 is in a middle position of its operating range, the UAV may maintain a hovering state in the vertical direction.

When the control mode of the UAV is the second control mode, the position of the accelerator control member 200 in its operating range is mapped to a power control value of a power motor of the UAV. The power motor is used to drive propellers of the UAV to rotate, thereby providing a power to drive the UAV to fly. This power may enable the UAV to achieve one or more degrees of freedom in motion. In some exemplary embodiments, the UAV may rotate about one or more axes of rotation. It should be understood that the power motor may be a DC motor or an AC motor. In addition, the power motor may be a brushless motor or a brushed motor.

In the case where the control mode of the UAV is the second control mode, when the accelerator control member 200 is in the middle position of its operating range, the UAV cannot maintain the hovering state in the vertical direction. Exemplarily, the operating range of the accelerator control member 200 may include a region of hovering range and corresponding limit positions at both ends of the range. For ease of description, they are referred to as a first limit position and a second limit position. In the case where the control mode of the UAV is the second control mode, when the accelerator control member 200 is located in the region of hovering range within its operating range, the UAV may maintain a hovering state in the vertical direction. When the accelerator control member 200 is at the first limit position in its operating range, the amount of accelerator control member displacement generated by the remote controller 1000 is a preset minimum power control value; as the accelerator control member 200 moves from the first limit position to the second limit position, the corresponding power control value gradually increases; when the accelerator control member 200 is at the second limit position in its operating range, the amount of accelerator control member displacement generated by the remote controller 1000 is a preset maximum power control value.

Exemplarily, the horizontal flight control member 300 includes, but is not limited to, a pitch control member, a roll control member, and the like. If the control mode of the UAV is the first control mode, the position of the pitch control member in its operating range may be mapped to a pitch attitude of the UAV or a horizontal velocity of the UAV in the horizontal direction as indicated by the pitch control member. The horizontal direction indicated by the pitch control member is the horizontal direction indicated by the UAV nose. The position of the roll control member in its operating range is mapped to a roll attitude of the UAV or a horizontal velocity of the UAV in the horizontal direction indicated by the roll control member. The horizontal direction indicated by the roll control member is a horizontal direction perpendicular to the horizontal direction indicated by the nose of the UAV.

In the case where the control mode of the UAV is the first control mode, when the pitch control member is in the middle position of its operating range, the pitch attitude of the UAV or the horizontal velocity of the UAV in the horizontal direction indicated by the pitch control member (that is, the horizontal direction indicated by the UAV nose) is 0. The UAV maintains a hovering state in the horizontal direction indicated by the pitch control member. In the case where the control mode of the UAV is the first control mode, when the roll control member is in the middle position of its operating range, the roll attitude of the UAV or the horizontal velocity of the UAV in the horizontal direction indicated by the roll control member (that is, the horizontal direction perpendicular to the horizontal direction indicated by the UAV nose) is 0. The UAV maintains a hovering state in the horizontal direction indicated by the roll control member.

If the control mode of the UAV is the second control mode, the position of the pitch control member in its operating range is mapped to an angular velocity that controls the pitch attitude of the UAV; the position of the roll control member in its operating range is mapped to the angular velocity controlling the roll attitude of the UAV. In the case where the control mode of the UAV is the second control mode, when the pitch control member is in the middle position of its operating range, the angular velocity of the pitch attitude of the UAV is 0. In the case where the control mode of the UAV is the second control mode, when the roll control member is in the middle position of its operating range, the angular velocity of the roll attitude of the UAV is 0.

The control device 400 of the UAV may be used to obtain the control mode switching request information of the UAV. The switching request information may be triggered by a user operating the remote controller 1000 to perform a corresponding mode switching operation, or may be sent by the UAV to the remote controller 1000. The embodiments of the present disclosure do not specifically limit the control mode switching request information of the UAV. The control device 400 of the UAV responds to the switching request information and detects whether the accelerator control member 200 is located at a position in the region of hovering range within its operating range; if the accelerator control member 200 is located in the region of hovering range, the control mode of the UAV is switched from the first control mode to the second control mode; otherwise, it may refuse to switch the control mode of the UAV from the first control mode to the second control mode, that is, does not respond to the switching request information, thereby avoiding the situation where the UAV may soar rapidly or even crash/fall apart. In this way, it is ensured that the UAV switches its control mode safely.

Exemplarily, the remote controller 1000 may further include a display device 500. The display device 500 includes, but is not limited to, an LCD display, an LED display, a touch screen, and the like. The display device 500 may be used to display operation assistance information of the accelerator control member 200, the horizontal flight control member 300, etc. The operation assistance information may be used to assist a user to operate the accelerator control member 200, the horizontal flight control member 300, etc. For example, it may assist the user to adjust the accelerator control member 200 within its operating range to the region of hovering range. By providing operation assistance to the user, the use experience of the user may be further improved.

It should be understood that the foregoing naming of the components of the remote controller 1000 is only for the purpose of indicator, and therefore does not limit the embodiments of the present disclosure.

The UAV control method provided by some exemplary embodiments of the present disclosure will be described in detail below on the basis of the remote controller 1000 and the UAV control device 400. It should be noted that the remote controller 1000 and the UAV control device 400 shown in FIG. 1 are only used to describe the UAV control method provided by some exemplary embodiments of the present disclosure; they do not constitute a limitation on the application scenarios of the UAV control method provided by some exemplary embodiments of the present disclosure.

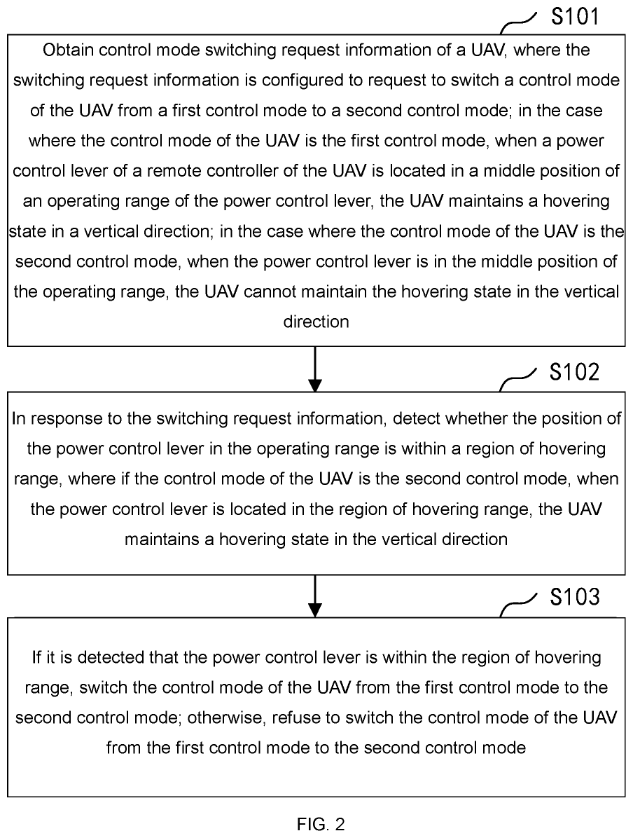

With reference to FIG. 2, FIG. 2 is a schematic flowchart of the steps of a control method for a UAV according to some exemplary embodiments of the present disclosure. This method may be used in the remote controller provided by the above exemplary embodiments, and may also be used in other devices that include a UAV control device. The application scenario of the method is not limited in this disclosure. Based on the control method of the UAV, it ensures that the control mode of the UAV is switched safely.

As shown in FIG. 2, the UAV control method may include steps S101 to S103.

S101. Obtain control mode switching request information of a UAV, where the switching request information is configured to request to switch a control mode of the UAV from a first control mode to a second control mode; in the case where the control mode of the UAV is the first control mode, when an accelerator control member of a remote controller of the UAV is located in a middle position of an operating range of the accelerator control member, the UAV maintains a hovering state in a vertical direction; in the case where the control mode of the UAV is the second control mode, when the accelerator control member is in the middle position of the operating range, the UAV cannot maintain the hovering state in the vertical direction.

The control modes of the UAV may include a plurality of control modes, such as the first control mode and the second control mode. Exemplarily, the first control mode may be a normal control mode, and the second control mode may be a manual control mode different from the normal control mode. For different control modes, the accelerator control member, pitch control member, roll control member and other control members of the remote controller may correspond to different control lever/member volume mappings.

For example, when the control mode of the UAV is the first control mode, the position of the accelerator control member in its operating range may be mapped to the velocity of the UAV in the vertical direction. When the control mode of the UAV is the second control mode, the position of the accelerator control member in its operating range may be mapped to the power control value of a power motor of the UAV.

In another example, when the control mode of the UAV is the first control mode, the position of the pitch control member in its operating range may be mapped to the pitch attitude of the UAV or the horizontal velocity of the UAV in the horizontal direction indicated by the pitch control member. The horizontal direction indicated by the pitch control member is the horizontal direction indicated by the nose of the UAV. When the control mode of the UAV is the second control mode, the position of the pitch control member in its operating range is mapped to an angular velocity controlling the pitch attitude of the UAV.

In yet another example, when the control mode of the UAV is the first control mode, the position of the roll control member in its operating range is mapped to the roll attitude of the UAV or the horizontal velocity of the UAV in the horizontal direction indicated by the roll control member. The horizontal direction indicated by the roll control member is the horizontal direction perpendicular to the horizontal direction indicated by the nose of the UAV. When the control mode of the UAV is the second control mode, the position of the roll control member in its operating range is mapped to an angular velocity controlling the roll attitude of the UAV.

Exemplarily, in the case where the control mode of the UAV is the first control mode, when the accelerator control member is in a middle position of its operating range, the UAV maintains a hovering state in the vertical direction. In the case where the control mode of the UAV is the second control mode, when the accelerator control member is in the middle position of its operating range, the UAV cannot maintain a hovering state in the vertical direction; while when the accelerator control member is in a region of hovering range within its operating range, the UAV maintains a hovering state in the vertical direction.

During the flight of the UAV, a user may perform a control operation of switching the control mode of the UAV from the first control mode to the second control mode by operating the remote controller of the UAV. When the remote controller detects such a control operation, it may trigger to obtain corresponding UAV control mode switching request information. It should be noted that the switching request information may also be obtained in other ways, and the present disclosure does not limit the specific way to obtain the switching request information.

S102. In response to the switching request information, detect whether the position of the accelerator control member in the operating range is within a region of hovering range, where if the control mode of the UAV is the second control mode, when the accelerator control member is located in the region of hovering range, the UAV maintains a hovering state in the vertical direction.

After obtaining the UAV control mode switching request information, in response to the switching request information, instead of directly switching the UAV control mode from the first control mode to the second control mode, first detect whether the location the accelerator control member in its operating range is within the region of hovering range. If the position of the accelerator control member in its operating range is not in the region of hovering range, once the control mode of the UAV is switched to the second control mode, the UAV cannot maintain the hovering state in the vertical direction, which may cause the UAV to soar quickly, posing a safety risk. If the accelerator control member is within the region of hovering range in its operating range, after the control mode of the UAV is switched to the second control mode, the UAV maintains a hovering state in the vertical direction.

In some exemplary embodiments, in response to the switching request information, determine a power control value corresponding to the position of the accelerator control member in its operating range, where different positions in the operating range may be mapped to different power control values. Exemplarily, when the accelerator control member is at a first limit position in its operating range, it may be mapped to a preset minimum power control value; when the accelerator control member is at a second limit position in its operating range, it may be mapped to a preset maximum power control value. In addition, the power control value range corresponding to the region of hovering range is also determined. Determine whether the power control value corresponding to the position of the accelerator control member in its operating range is within a range of power control value corresponding to the region of hovering range; if the power control value is within such a range of the power control value, it may be determined that the position of the accelerator control member in its operating range is within the region of hovering range. On the contrary, if the power control value is outside the range of the power control value, it may be determined that the position of the accelerator control member in its operating range is not within the region of hovering range.

In some exemplary embodiments, in response to the switching request information, determine a position angle corresponding to the position of the accelerator control member in its operating range, and a position angle range corresponding to the region of hovering range. Determine whether the position angle corresponding to the position of the accelerator control member in its operating range is within the range of the position angle corresponding to the region of hovering range; if the position angle is within the position angle range, it may be determined that the position of the accelerator control member in its operating range is within the region of hovering range. On the contrary, if the position angle is outside the position angle range, it may be determined that the position of the accelerator control member in its operating range is not within the region of hovering range. For example, if it is determined that the position angle corresponding to the position of the accelerator control member in its operating range is −17 degrees, and the region of hovering range corresponds to a position angle range of [−20, −15] degrees, it may be determined that the position of the accelerator control member in its operating range is within the region of hovering range.

S103. If it is detected that the accelerator control member is within the region of hovering range, switch the control mode of the UAV from the first control mode to the second control mode; otherwise, refuse to switch the control mode of the UAV from the first control mode to the second control mode.

If the accelerator control member is within the region of hovering range, that is to say, after the control mode of the UAV is switched to the second control mode, the UAV can maintain the hovering state in the vertical direction, in such a case, the control mode of the UAV is switched from the first control mode to the second control mode. On the contrary, if the accelerator control member is not within the region of hovering range, refuse to switch the control mode of the UAV from the first control mode to the second control mode. In this way, the situation of UAV rising quickly may be avoided, and potential safety risks may be eliminated.

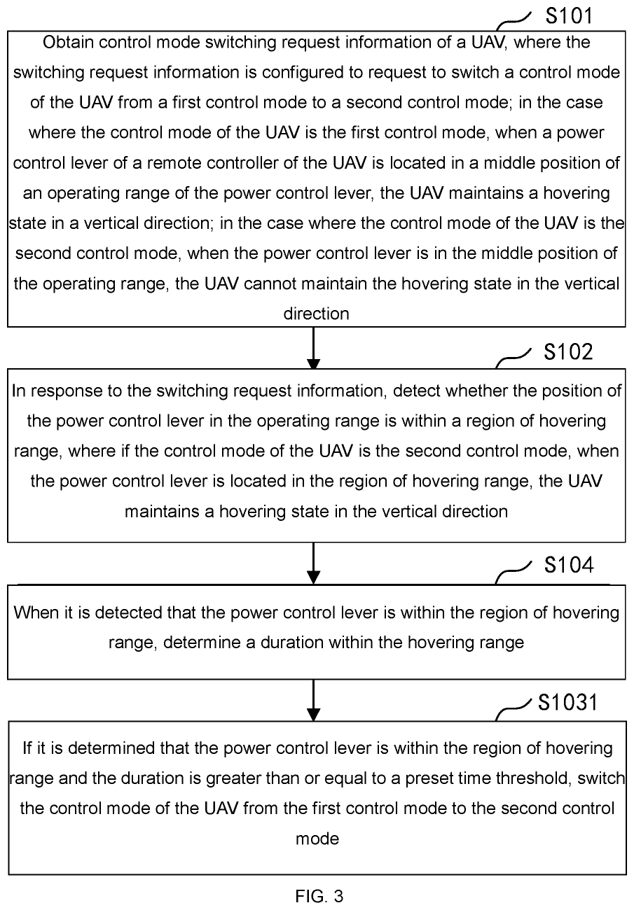

In some exemplary embodiments, as shown in FIG. 3, after the step S102, a step S104 is also included, and the step S103 may include a sub-step S1031.

S104. When it is detected that the accelerator control member is within the region of hovering range, determine a duration within the hovering range.

In order to further ensure the safety of UAV switching control mode, when the accelerator control member is determined to be within the region of hovering range, time the duration for which the accelerator control member is within the region of hovering range. Exemplarily, a timer may be pre-installed in the remote controller of the UAV. When it is determined that the accelerator control member is within the region of hovering range, start the timer for timing, and then stop timing when the accelerator control member is no longer within the region of hovering range or the timing reaches a preset time threshold.

S1031. If it is determined that the accelerator control member is within the region of hovering range and the duration is greater than or equal to a preset time threshold, switch the control mode of the UAV from the first control mode to the second control mode.

If it is determined that the accelerator control member is within the region of hovering range and the duration is greater than or equal to the preset time threshold, that is to say, the accelerator control member is stably located in the region of hovering range, in such a case, switch the control mode of the UAV from the first control mode to the second control mode. On the contrary, if the accelerator control member is not within the region of hovering range, or the accelerator control member is located in the region of hovering range but the duration is less than the preset time threshold, refuse to switch the control mode of the UAV from the first control mode to the second control mode.

In some exemplary embodiments, the control method of the UAV may further include: outputting first operation assistance information of the accelerator control member, where the first operation assistance information is configured to assist a user to adjust the position of the accelerator control member in the operating range to within the region of hovering range.

In order to improve user experience, after obtaining the control mode switching request information of the UAV, in response to the switching request information, output corresponding accelerator control member operation assistance information. For ease of description, the operation assistance information of the accelerator control member is referred to as first operation assistance information hereinafter. The first operation assistance information is configured to assist a user to adjust the position of the accelerator control member in its operating range to within the region of hovering range.

Exemplarily, the first operation assistance information may include at least one of the following: a voice prompt, a graphic indicator, or a text indicator. For example, a voice prompt for controlling the accelerator control member may be output by sound.

Exemplarily, the outputting of the first operation assistance information of the accelerator control member may include: displaying the first operation assistance information of the accelerator control member.

For example, the first operation assistance information of the accelerator control member may be displayed on a display device such as a display screen by means of graphics, text, etc.

Exemplarily, the displaying of the first operation assistance information of the accelerator control member may include: displaying a graphic indicator indicating whether the position of the accelerator control member in the operating range is within the region of hovering range.

For example, a graphic indicator indicating to adjust the accelerator control member in its operating range to the region of hovering range may be displayed on a corresponding control interface of the remote controller.

In some exemplary embodiments, the displaying of the graphic indicator indicating whether the position of the accelerator control member in the operating range is located in the region of hovering range may include: displaying a first graphic indicator, where the first graphic indicator is configured to indicate the operating range; displaying a second graphic indicator, where the second graphic indicator is configured to indicate the position of the accelerator control member in the operating range; and displaying a third graphic indicator, where the third graphic indicator is configured to indicate the position of the region of hovering range in the operating range.

The graphic indicator herein may include the first graphic indicator, the second graphic indicator and the third graphic indicator, where the first graphic indicator is configured to indicate the operating range of the accelerator control member, the second graphic indicator is configured to indicate the position of the accelerator control member in the operating range, and the third graphic indicator is configured to indicate the position of the region of hovering range in the operating range. Exemplarily, the first graphic indicator, the second graphic indicator and the third graphic indicator may be set in the same or different shapes, such as a circular shape, a bar shape, and so on. In addition, the first graphic indicator, the second graphic indicator and the third graphic indicator may also be labeled with corresponding colors for display, such as white, gray, green, black and other different colors.

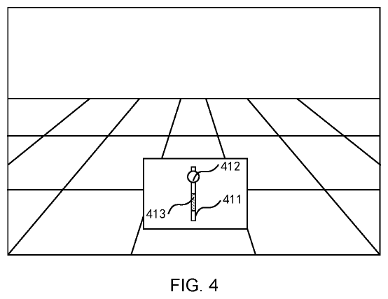

For example, as shown in FIG. 4, FIG. 4 is a schematic diagram of an interface displaying a graphic indicator. In FIG. 4, the first graphic indicator 411 (indicating the operating range of the accelerator control member) is set in the shape of a bar and labeled with a first color for display; the second graphic indicator 412 (indicating the position of the accelerator control member in the operating range) is set in a circular shape and labeled with a second color for display, and the third graphic indicator 413 (indicating the position of the region of hovering range in the operating range) is set in the shape of a bar and labeled with a third color for display. The first color, the second color, and the third color may be different from each other. Alternatively, the first color, the second color, and the third color may be the same. This is not limited in this disclosure.

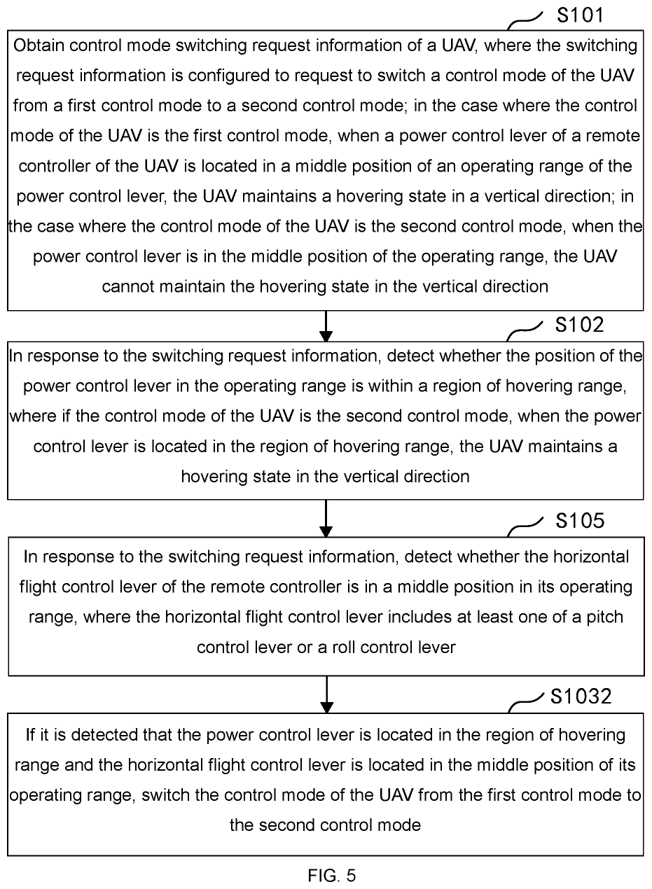

In some exemplary embodiments, as shown in FIG. 5, step S105 is further included after step S101, and step S103 may include sub-step S1032.

S105. In response to the switching request information, detect whether the horizontal flight control member of the remote controller is in a middle position in its operating range, where the horizontal flight control member includes at least one of a pitch control member or a roll control member.

Exemplarily, in addition to the accelerator control member, the remote controller may further include a horizontal flight control member, and the horizontal flight control member may include a pitch control member, a roll control member, and so on. When the control mode of the UAV is the first control mode, the position of the pitch control member in its operating range may be mapped to the pitch attitude of the UAV or the horizontal velocity of the UAV in the horizontal direction indicated by the pitch control member. The horizontal direction indicated by the pitch control member is a horizontal direction indicated by the nose of the UAV. The position of the roll control member in its operating range is mapped to the roll attitude of the UAV or the horizontal velocity of the UAV in the horizontal direction indicated by the roll control member. The horizontal direction indicated by the roll control member is the horizontal direction perpendicular to the horizontal direction indicated by the nose of the UAV.

In the case where the control mode of the UAV is the first control mode, when the pitch control member is in a middle position of its operating range, the pitch attitude of the UAV or the horizontal velocity of the UAV in the horizontal direction indicated by the pitch control member (that is, the horizontal direction indicated by the nose of the UAV) is 0, and the UAV maintains a hovering state in the horizontal direction indicated by the pitch control member. In the case where the control mode of the UAV is the first control mode, when the roll control member is in a middle position of its operating range, the roll attitude of the UAV or the horizontal velocity of the UAV in the horizontal direction indicated by the roll control member (that is, the horizontal direction perpendicular to the horizontal direction indicated by the nose of the UAV) is 0, and the UAV maintains a hovering state in the horizontal direction indicated by the roll control member.

When the control mode of the UAV is the second control mode, the position of the pitch control member in its operating range is mapped to an angular velocity that controls the pitch attitude of the UAV. The position of the roll control member in its operating range is mapped to an angular velocity that controls the roll attitude of the UAV.

In the case where the control mode of the UAV is the second control mode, when the pitch control member is in a middle position of its operating range, the angular velocity of the pitch attitude of the UAV is 0. In the case where the control mode of the UAV is the second control mode, when the roll control member is in a middle position of its operating range, the angular velocity of the roll attitude of the UAV is 0.

In order to further ensure the safety of the UAV when switching control modes, after obtaining the UAV control mode switching request information, in response to the switching request information, in addition to detecting whether the position of the accelerator control member in its operating range is within the region of hovering range, it is also detected whether the position of the horizontal flight control member is in the middle position of its operating range; that is to say, detecting whether the pitch control member is in the middle position of its operating range, and whether the roll control member is in the middle position of its operating range.

S1032. If it is detected that the accelerator control member is located in the region of hovering range and the horizontal flight control member is located in the middle position of its operating range, switch the control mode of the UAV from the first control mode to the second control mode.

If the accelerator control member is in the region of hovering range and the horizontal flight control member is in the middle position of its operating range, that is, the pitch control member is in the middle position of its operating range and the roll control member is in the middle position of its operating range, in such a case, the control mode of the UAV may be switched from the first control mode to the second control mode. Since the pitch control member is in the middle position of its operating range and the roll control member is also in the middle position of its operating range, the angular velocities of the pitch attitude and the roll attitude of the corresponding UAV are 0. Therefore, switching to the second control mode will not cause the UAV to fail in its attitude. In this way, the safety for switching the control mode of the UAV may be further improved.

If the accelerator control member is outside the region of hovering range, or the pitch control member is not in the middle position of its operating range, or the roll control member is not in the middle position of its operating range, in such a case, it is refused to switch the control mode of the UAV from the first control mode to the second control mode.

In some exemplary embodiments, the control method of the UAV may further include: outputting second operation assistance information of the horizontal flight control member, where the second operation assistance information is configured to assist a user to adjust the horizontal flight control member to a middle position in its operating range.

In order to improve user experience, after obtaining the UAV control mode switching request information, in response to the switching request information, output the operation assistance information of the corresponding horizontal flight control member (pitch control member, roll control member, etc.). For ease of description, the operation assistance information of the horizontal flight control member is referred to as the second operation assistance information. The second operation assistance information is configured to assist a user to adjust the horizontal flight control member to the middle position in its operating range.

Exemplarily, the second operation assistance information may include at least one of the following: a voice prompt, a graphic indicator, or a text identifier. For example, a voice prompt for controlling the horizontal flight control member may be output by sound.

Exemplarily, the outputting of the second operation assistance information of the horizontal flight control member may include: displaying the second operation assistance information of the horizontal flight control member.

For example, the second operation assistance information of the horizontal flight control member may be displayed on a display device such as a display screen by means of graphics and text.

Exemplarily, the displaying of the second operation assistance information of the horizontal flight control member may include: displaying a graphic indicator indicating whether the horizontal flight control member is in the middle position of its operating range.

For example, a graphic indicator indicating to adjust the horizontal flight control member to the middle position in its operating range may be displayed on the corresponding control interface of the remote controller.

In some exemplary embodiments, the displaying of the graphic indicator indicating whether the horizontal flight control member is in the middle position of its operating range may include: displaying a fourth graphic indicator, where the fourth graphic indicator is configured to indicate the operating range of the horizontal flight control member; displaying a fifth graphic indicator, where the fifth graphic indicator is configured to indicate the position of the horizontal flight control member in its operating range; and displaying a sixth graphic indicator, where the sixth graphic indicator is configured to indicate that the horizontal flight control member is in the middle position in its operating range.

The graphic indicator may include a fourth graphic indicator, a fifth graphic indicator and a sixth graphic indicator. The fourth graphic indicator may be configured to indicate the operating range of the horizontal flight control member, the fifth graphic indicator may be configured to indicate the position of the horizontal flight control member in its operating range, and the sixth graphic indicator may be configured to indicate that the horizontal flight control member is in the middle position in its operating range. Exemplarily, the fourth graphic indicator, the fifth graphic indicator and the sixth graphic indicator may be set in the same or different shapes, such as a circular shape, a bar shape and so on. In addition, the fourth graphic indicator, the fifth graphic indicator and the sixth graphic indicator may also be displayed with corresponding colors, for example, displayed in different colors such as white, gray, green, and black.

In some exemplary embodiments, after obtaining the control mode switching request information of the UAV, in response to the switching request information, determine a power control value corresponding to the position of the accelerator control member in its operating range, where different positions in the operating range may be mapped to different power control values.

After determining the power control value corresponding to the position of the accelerator control member in its operating range, the power output is not immediately/directly adjusted to the power control value, rather the power output is gradually adjusted to the power control value according to a preset power control value gradual increase rule. Subsequently, the control mode of the UAV may be switched from the first control mode to the second control mode. Since the power output is increased slowly and gradually, rather than rapidly and suddenly, the case that the UAV soars rapidly may be avoided, thereby improving the safety of the UAV switching control mode.

In the above exemplary embodiments, upon obtaining the UAV control mode switching request information (for requesting to switch the UAV control mode from the first control mode to the second control mode), in response to the switching request information, it is detected whether the accelerator control member of the remote controller of the UAV is in the region of hovering range in its operating range. In the case where the control mode of the UAV is the first control mode, when the accelerator control member is in the middle position of its operating range, the UAV may maintain a hovering state in the vertical direction; in the case where the control mode of the UAV is the second control mode, when the accelerator control member is in the middle position of its operating range, the UAV may not maintain the hovering state in the vertical direction; when the accelerator control member is within the region of hovering range, the UAV may maintain the hovering state in the vertical direction. If it is detected that the accelerator control member is within the region of hovering range, switch the control mode of the UAV from the first control mode to the second control mode; otherwise, refuse to switch the control mode of the UAV from the first control mode to the second control mode, so as to avoid the situation where the UAV soars into the sky or even crash/fall apart. Therefore, it is ensured that the UAV switches its control mode safely.

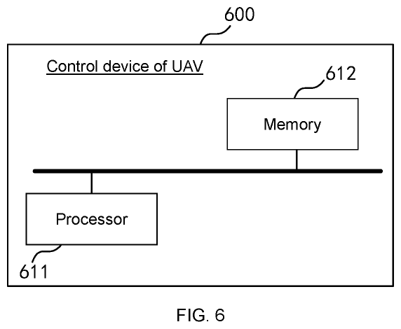

With reference to FIG. 6, FIG. 6 is a schematic block diagram of a control device for an UAV according to some exemplary embodiments of the present disclosure.

As shown in FIG. 6, a UAV control device 600 may include a (at least one) processor 611 and a (at least one) memory 612. The processor 611 and the memory 612 are connected via a bus, where the bus may be, for example, an I2C (Inter-integrated Circuit) bus.

Specifically, the processor 611 may be a micro-controller unit (MCU), a central processing unit (CPU), or a digital signal processor (DSP), etc.

Specifically, the memory 612 may be a Flash chip, a read-only memory (ROM) disk, an optical disk, a U (USB) disk, or a mobile hard disk. Various computer programs for the processor 611 to execute may be stored in the memory 612.

The processor may be configured to execute a computer program stored in the memory, and implement the following steps when executing the computer program.

Obtain control mode switching request information of a UAV, where the switching request information is configured to request to switch a control mode of the UAV from a first control mode to a second control mode; in the case where the control mode of the UAV is the first control mode, when an accelerator control member of a remote controller of the UAV is located in a middle position of an operating range of the accelerator control member, the UAV maintains a hovering state in a vertical direction; in the case where the control mode of the UAV is the second control mode, when the accelerator control member is in the middle position of the operating range, the UAV cannot maintain the hovering state in the vertical direction.

In response to the switching request information, detect whether the position of the accelerator control member in the operating range is within a region of hovering range, where if the control mode of the UAV is the second control mode, when the accelerator control member is located in the region of hovering range, the UAV maintains a hovering state in the vertical direction.

If detect that the accelerator control member is within the region of hovering range, switch the control mode of the UAV from the first control mode to the second control mode; otherwise, refuse to switch the control mode of the UAV from the first control mode to the second control mode.

In some exemplary embodiments, the processor is further configured to execute the following performance.

When it is detected that the accelerator control member is within the region of hovering range, determine a duration within the hovering range.

When the processor implements the step of switching the control mode of the UAV from the first control mode to the second control mode if the accelerator control member is detected to be within the region of hovering range, the processor executes as follows.

If it is determined that the accelerator control member is within the region of hovering range and the duration is greater than or equal to a preset time threshold, switching the control mode of the UAV from the first control mode to the second control mode model.

In some exemplary embodiments, the processor is further configured to execute the following performance.

Output first operation assistance information of the accelerator control member, where the first operation assistance information is configured to assist a user to adjust the position of the accelerator control member in the operating range to the region of hovering range.

In some exemplary embodiments, the first operation assistance information includes at least one of the following: a voice prompt, a graphic indicator, or a text indicator.

In some exemplary embodiments, to output the first operation assistance information of the accelerator control member, the processor executes as follows.

Display the first operation assistance information of the accelerator control member.

In some exemplary embodiments, to display the first operation assistance information of the accelerator control member, the processor executes as follows.

Display a graphic indicator indicating whether the position of the accelerator control member in the operating range is in the region of hovering range.

In some exemplary embodiments, to display the graphic indicator indicating whether the position of the accelerator control member in the operating range is located in the region of hovering range, the processor executes as follows.

Display a first graphic indicator, where the first graphic indicator is configured to indicate the operating range;

Display a second graphic indicator, where the second graphic indicator is configured to indicate the position of the accelerator control member in the operating range;

Display a third graphic indicator, where the third graphic indicator is configured to indicate the position of the region of hovering range in the operating range.

In some exemplary embodiments, the processor is further configured to perform as follows.

In response to the switching request information, detect whether the horizontal flight control member of the remote controller is in the middle position in its operating range, where the horizontal flight control member includes at least one of a pitch control member or a roll control member.

To switch the control mode of the UAV from the first control mode to the second control mode if the accelerator control member is detected to be within the region of hovering range, the processor executes as follows.

If it is detected that the accelerator control member is located in the region of hovering range and the horizontal flight control member is in the middle position of its operating range, switch the control mode of the UAV from the first control mode to the second control mode.

In some exemplary embodiments, the processor is further configured to perform as follows.

Output second operation assistance information of horizontal flight control member, where the second operation assistance information is configured to assist a user to adjust the horizontal flight control member in its operating range to the middle position.

In some exemplary embodiments, the second operation assistance information includes at least one of the following: a voice prompt, a graphic indicator, or a text indicator.

In some exemplary embodiments, to output the second operation assistance information of the horizontal flight control member, the processor executes as follows.

Display the second operation assistance information of the horizontal flight control member.

In some exemplary embodiments, to display the second operation assistance information of the horizontal flight control member, the processor executes as follows.

Display a graphic indicator indicating whether the horizontal flight control member is in the middle position of its operating range.

In some exemplary embodiments, to display the graphic indicator indicating whether the horizontal flight control member is in the middle position of its operating range, the processor executes as follows.

Display a fourth graphic indicator, where the fourth graphic indicator is configured to indicate the operating range of the horizontal flight control member.

Display a fifth graphic indicator, where the fifth graphic indicator is configured to indicate the position of the horizontal flight control member in the operating range.

Display a sixth graphic indicator, where the sixth graphic indicator is configured to indicate that the horizontal flight control member is in the middle position within the operating range.

In some exemplary embodiments, in the case where the control mode of the UAV is the first control mode, when the pitch control member is in the middle position of its operating range, the UAV may maintain a hovering state in a horizontal direction indicated by the pitch control member; when the roll control member is in the middle position of its operating range, the UAV may maintain a hovering state in a horizontal direction indicated by the roll control member.

In some exemplary embodiments, if the control mode of the UAV is the second control mode, the position of the pitch control member in its operating range may be mapped to an angular velocity controlling the pitch attitude of the UAV; the position of the roll control member in its operating range may be mapped to an angular velocity controlling the roll attitude of the UAV. When the pitch control member is in the middle of its operating range, the angular velocity of the pitch attitude of the UAV is 0; when the roll control member is in the middle position of its operating range, the angular velocity of the roll attitude of the UAV is 0.

Embodiments of the present disclosure further provide a computer-readable storage medium. The computer-readable storage medium stores a computer program. The computer program includes program instructions. The processor executes the program instructions to implement the steps of the UAV control method provided in the embodiments of the present disclosure.

The computer-readable storage medium may be an internal storage unit of the remote controller or UAV control device described in the foregoing exemplary embodiments, such as a hard disk or memory of the remote controller or the UAV control device. The computer-readable storage medium may also be an external storage device of the remote controller or the control device of the UAV, for example, a plug-in hard disk, a smart media card (SMC), a secure digital (SD) card, a flash memory card (Flash card), etc. equipped on the remote controller or the control device of the UAV.

The above are only some specific exemplary embodiments of the present disclosure; they do not limit the scope of protection of the present disclosure. A person skilled in the art may easily think of various equivalent modifications or replacements within the technical scope disclosed herein. These modifications or replacements should all be covered within the scope of protection of this disclosure. Therefore, the scope of protection of the present disclosure should be based on the scope of protection defined by the appended claims.

What is claimed is:

1. A method for controlling an aircraft, comprising:
obtaining request information, wherein the request information is configured to request switching a control mode of the aircraft to a preset control mode;
detecting, based on the request information, whether a current position of an accelerator control member of a remote controller of the aircraft is within a preset range region;
in response to the current position of the accelerator control member being within the preset range region, controlling the aircraft to enter a preset control mode; and
in response to the current position of the accelerator control member not being within the preset range region, prohibiting the aircraft from entering the preset control mode.

2. The method according to claim 1, wherein the preset range region includes at least a hovering position point; and
when the aircraft is at the hover position point, the aircraft hovers in a vertical direction.

3. The method according to claim 2, wherein the hovering position point is located in a middle position of the preset range region.

4. The method according to claim 1, wherein the control mode includes at least a first control mode and a second control mode;
the preset control mode is one of the first control mode and the second control mode;
the preset range region includes at least a first preset range region corresponding to the first control mode and a second preset range region corresponding to the second control mode; and
the first preset range region is different from the second preset range region.

5. The method according to claim 4, wherein when the control mode of the aircraft is the first control mode, and the accelerator control member is located in a middle position of an operating range of the accelerator control member, the aircraft maintains a hovering state in a vertical direction, and the first preset range region includes the middle position of the operating range of the accelerator control member; and
when the control mode of the aircraft is the second control mode, and the accelerator control member is located in the middle position of the operating range, the aircraft does not maintain the hovering state in the vertical direction, and the second preset range region includes a portion other than the middle position of the operating range of the accelerator control member.

6. The method according to claim 1, further comprising:
in response to the accelerator control member being within the preset range region, determining a duration of the accelerator control member being within the preset range region, wherein
the controlling of the aircraft to enter the preset control mode in response to the current position of the accelerator control member being within the preset range region includes:
in response to the current position of the accelerator control member being within the preset range region and the duration is greater than or equal to a preset time threshold, controlling the aircraft to enter the preset control mode.

7. The method according to claim 1, further comprising:
outputting first operation assistance information of the accelerator control member, wherein the first operation assistance information is configured to assist a user to adjust a position of the accelerator control member in an operating range thereof to the preset range region.

8. The method according to claim 7, wherein the first operation assistance information includes at least one of a voice prompt, a graphic indicator, or a text indicator.

9. The method according to claim 1, further comprising:
in response to the request information, detecting whether a horizontal flight control member of the remote controller is located in a preset position region in an operating range thereof, wherein,
the horizontal flight control member includes at least one of a pitch control member, or a roll control member, and
the controlling of the aircraft to enter a preset control mode in response to the current position of the accelerator control member being within the preset range region includes:
in response to the current position of the accelerator control member being within the preset range region and the horizontal flight control member being within the preset position region, controlling of the aircraft to enter the preset control mode.

10. The method according to claim 9, wherein the preset position region includes a middle position of the operating range of the horizontal flight control member.

11. The method according to claim 9, further comprising:
outputting second operation assistance information of the horizontal flight control member, wherein
the second operation assistance information is configured to assist a user to adjust the horizontal flight control member in the operating range thereof to the preset position region.

12. The method according to claim 11, wherein the second operation assistance information includes at least one of a voice prompt, a graphic indicator, or a text indicator.

13. The method according to claim 9, wherein the control modes include at least a first control mode and a second control mode, and the preset control mode is one of the first control mode and the second control mode;
in the first control mode, when the pitch control member is in a middle position of its operating range, the aircraft maintains a hovering state in a horizontal direction indicated by the pitch control member, and when the roll control member is in a middle position of its operating range, the aircraft maintains a hovering state in a horizontal direction indicated by the roll control member.

14. The method according to claim 13, wherein in the second control mode, a position of the pitch control member in its operating range is mapped to an angular velocity controlling a pitch attitude of the aircraft, and a position of the roll control member in its operating range is mapped to an angular velocity controlling a roll attitude of the aircraft; when the pitch control member is in a middle position of its operating range, the angular velocity controlling the pitch attitude of the aircraft is 0, and when the roll control member is in a middle of its operating range, the angular velocity controlling the roll attitude of the aircraft is 0.

15. A method for controlling an aircraft, comprising:
obtaining request information, wherein the request information is configured to request switching a control mode of the aircraft to a preset control mode;
detecting, based on the request information, whether a current position of an accelerator control member of a remote controller of the aircraft is within a preset range region;
in response to the current position of the accelerator control member being within the preset range region, controlling the aircraft to enter a preset control mode; and
controlling the aircraft to maintain a hovering state in a vertical direction when the aircraft enters the preset control mode.

16. The method according to claim 15, further comprising:
in response to the current position of the accelerator control member not being within the preset range region, prohibiting the aircraft from entering the preset control mode.

17. The method according to claim 15, wherein the control mode includes at least a first control mode and a second control mode;
the preset control mode is one of the first control mode and the second control mode;
the preset range region includes at least a first preset range region corresponding to the first control mode and a second preset range region corresponding to the second control mode; and
the first preset range region is different from the second preset range region.

18. The method according to claim 17, wherein when the control mode of the aircraft is the first control mode, and the accelerator control member is located in a middle position of an operating range of the accelerator control member, the aircraft maintains a hovering state in a vertical direction, and the first preset range region includes the middle position of the operating range of the accelerator control member; and
when the control mode of the aircraft is the second control mode, and the accelerator control member is located in the middle position of the operating range, the aircraft does not maintain the hovering state in the vertical direction, and the second preset range region includes a portion other than the middle position of the operating range of the accelerator control member.

19. The method according to claim 15, further comprising:
in response to the accelerator control member being within the preset range region, determining a duration of the accelerator control member being within the preset range region, wherein
the controlling of the aircraft to enter the preset control mode in response to the current position of the accelerator control member being within the preset range region includes:
in response to the current position of the accelerator control member being within the preset range region and the duration is greater than or equal to a preset time threshold, controlling the aircraft to enter the preset control mode.

20. A control device for an aircraft, comprising:
at least one storage medium storing a set of instructions for aircraft controlling; and
at least one processor in communication with the at least one storage medium, wherein during operation, the at least one processor executes the set of instructions to:
obtain request information, wherein the request information is configured to request switching a control mode of the aircraft to a preset control mode,
detect, based on the request information, whether a current position of an accelerator control member of a remote controller of the aircraft is within a preset range region,
in response to the current position of the accelerator control member being within the preset range region, control the aircraft to enter a preset control mode, and
in response to the current position of the accelerator control member not being within the preset range region, prohibit the aircraft from entering the preset control mode.
